(19) United States
(12) Patent Application Publication
(10) Pub. No.: US 2025/0137313 A1
(43) Pub. Date: May 1, 2025

(54) AUTOMATIC GARAGE DOOR SAFETY SYSTEM AND METHOD THEREFOR

(71) Applicants: Donald J. Schamus, Pittsburgh, PA (US); Ronald F. Schamus, Pittsburgh, PA (US)

(72) Inventors: Donald J. Schamus, Pittsburgh, PA (US); Ronald F. Schamus, Pittsburgh, PA (US)

(21) Appl. No.: 18/797,199

(22) Filed: Aug. 7, 2024

Related U.S. Application Data
(60) Provisional application No. 63/593,421, filed on Oct. 26, 2023.

(51) Int. Cl. E05F 15/72; E05F 15/668

(52) U.S. Cl. CPC E05F 15/72; E05F 15/668; E05Y 2800/42; E05Y 2900/106

(57) ABSTRACT

An automatic garage door safety system includes a drive assembly, a detection assembly, a control unit, and a housing. The drive assembly includes a motor and a mechanical arm assembly designed to operatively connect the motor to a garage door. The detection assembly is designed to detect an atmospheric condition in a room openable and closable by a garage door. The control unit is operatively connected to the motor and the detection assembly and designed to activate the motor to open a garage door upon receiving information from the detection assembly indicating an atmospheric condition hazardous to humans. The housing contains the motor, the detection assembly, and the control unit.

### CROSS-REFERENCE TO RELATED APPLICATIONS

I hereby claim the benefit under 35 U.S.C. Section 119 (e) of U.S. Provisional Application No. 63/593,421, filed Oct. 26, 2023, which application is incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to garage door openers and more particularly pertains to a new automatic garage door safety system for automatically opening a garage door of a room that is openable and closable by the garage door when the automatic garage door safety system detects hazardous conditions in the room, such as carbon monoxide, smoke, or other gases or airborne materials, that could result in asphyxiation of persons or animals in the room.

### (2) Description of Related Art Including Information Disclosed Under 37 CFR 1.97 and 1.98

The prior art relates to garage door openers. The prior art, as best understood, does not disclose an automatic garage door safety system that includes a detection assembly and a control unit that automatically opens a garage door when the detection assembly detects an atmospheric condition hazardous to humans.

### BRIEF SUMMARY OF THE INVENTION

An embodiment of the disclosure meets the needs presented above in a automatic garage door safety system generally comprising a drive assembly, a detection assembly, a control unit, and a housing. The drive assembly includes a motor and a mechanical arm assembly designed to operatively connect the motor to a garage door. The detection assembly is designed to detect an atmospheric condition in a room openable and closable by a garage door. The control unit is operatively connected to the motor and the detection assembly and designed to activate the motor to open a garage door upon receiving information from the detection assembly indicating an atmospheric condition hazardous to humans. The housing contains the motor, the detection assembly, and the control unit.

The automatic garage door safety system could open the garage door to permit ventilation of the room and the entry of fresh air when a hazardous condition is detected. The automatic opening would help prevent accidental asphyxiation of humans or animals due to a garage being filled with smoke, carbon monoxide, or other such gases or airborne materials.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of an automatic garage door safety system according to an embodiment of the disclosure.

FIG. 2 is a top view of an embodiment of the disclosure.

FIG. 3 is a perspective view of an embodiment of the disclosure in use.

FIG. 4 is a perspective view of an embodiment of the disclosure in use.

FIG. 5 is a box diagram showing a relationship of an embodiment of the disclosure.

### DETAILED DESCRIPTION OF THE INVENTION

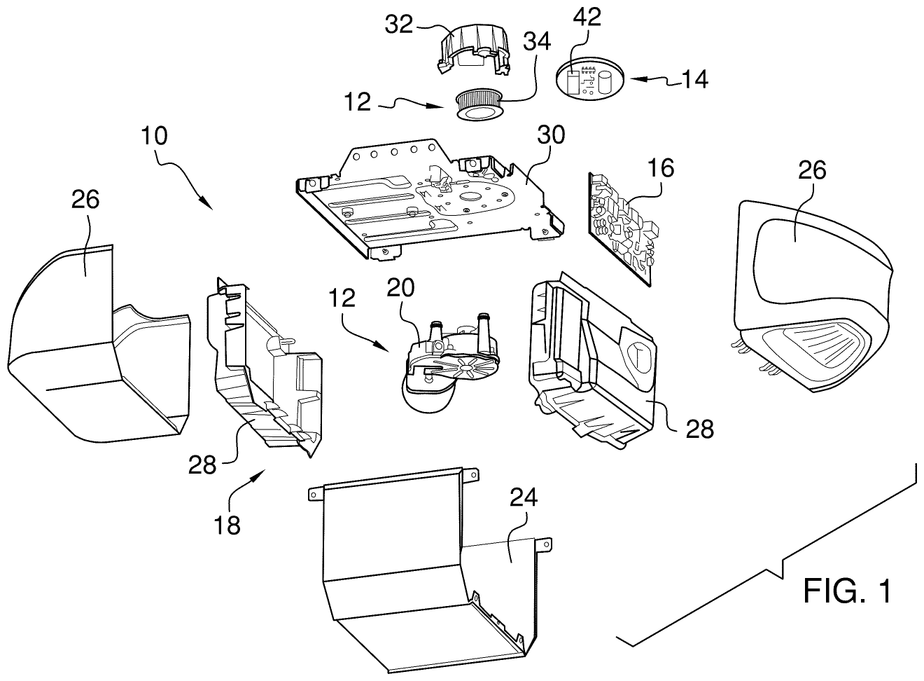

With reference now to the drawings, and in particular to FIGS. 1 through 5 thereof, a new automatic garage door safety system embodying the principles and concepts of an embodiment of the disclosure and generally designated by the reference numeral 10 will be described.

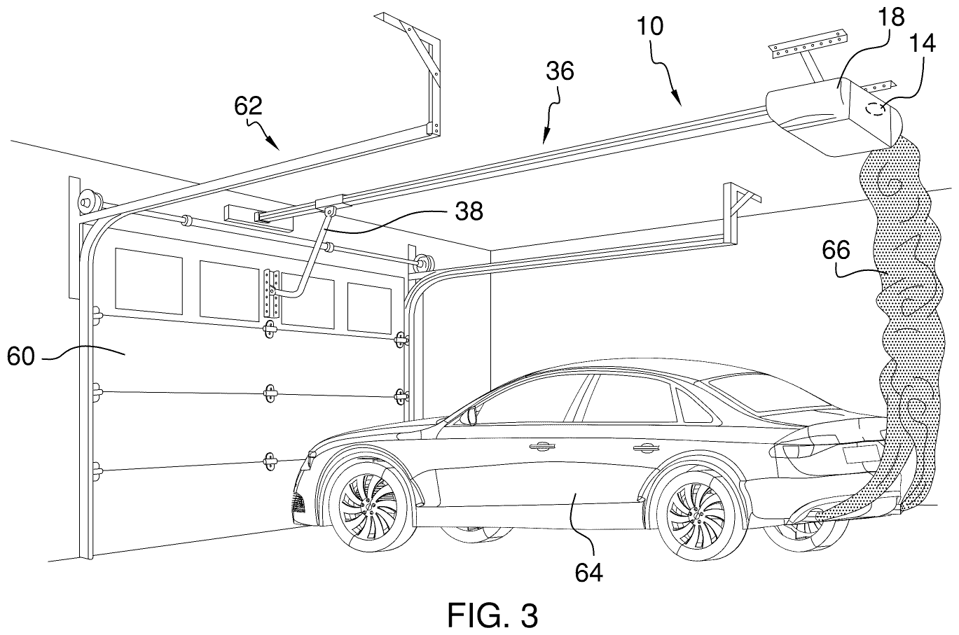

As best illustrated in FIGS. 1 through 5, the automatic garage door safety system 10 generally comprises a drive assembly 12, a detection assembly 14, a control unit 16, and a housing 18. The drive assembly 12 includes a motor 20 and a mechanical arm assembly 22 designed to operatively connect the motor 20 to a garage door 60, as shown in FIG. 3. FIG. 1 shows an exemplary embodiment of components of the automatic garage door safety system 10, wherein the detection assembly 14 and the control unit 16 are integrated into a standard type of garage door opener. It should be understood that the components shown are one example of a type of garage door opener, and that virtually any type of garage door opener can be integrated into the automatic garage door safety system 10. The housing 18 as shown in FIG. 1 includes a motor cover 24, two end caps 26, two end panels 28, a mounting plate 30, and a belt sprocket cover 32. In addition to the motor 20, the drive assembly 12 could also include a belt sprocket 34, which connects to the mechanical arm assembly 22. As shown in FIG. 3, the mechanical arm assembly 22 could be a sliding trolley track 36 with a pivot arm 38 that connects to the garage door 60. The mechanical arm assembly 22 could also be a screw drive.

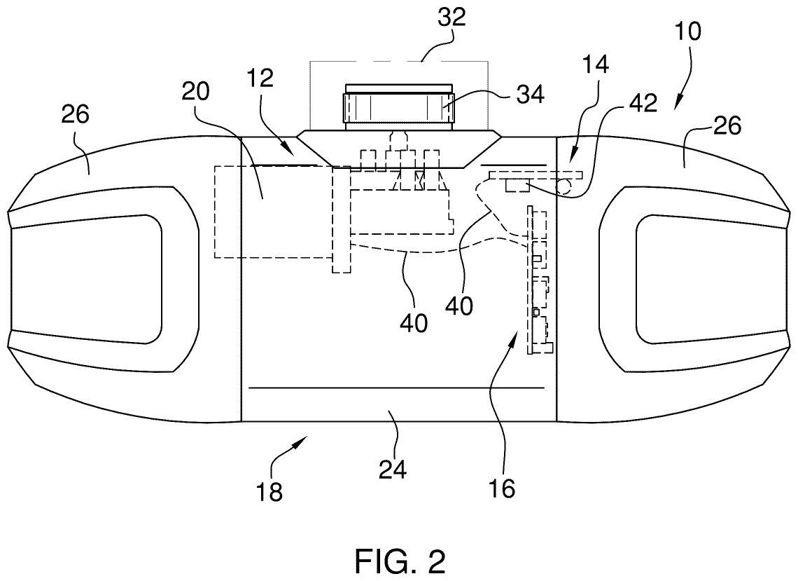

FIG. 2 shows the components of the automatic garage door safety system 10 shown in FIG. 1 assembled. The detection assembly 14 is designed to detect an atmospheric condition in a room 62 openable and closable by the garage door 60. The control unit 16 is operatively connected to the motor 20 and the detection assembly 14 and designed to activate the motor 20 to open the garage door 60 upon receiving information from the detection assembly 14 indicating an atmospheric condition hazardous to humans. As shown in FIG. 2, the housing 18 contains the motor 20, the detection assembly 14, and the control unit 16. The control unit 16 is connected to each of the motor 20 and the detection assembly 14 by electric wires 40. The control unit 16 includes a microprocessor to control operation of the automatic garage door safety system 10. In one possible embodiment, the connection could be wireless.

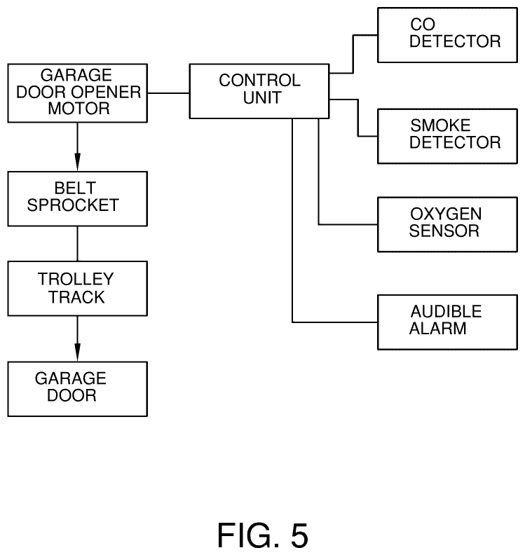

The detection assembly 14 includes a detector or sensor 42, which could be a smoke detector, a carbon monoxide detector, or an oxygen sensor. In the exemplary embodiment shown in FIG. 5, the detection assembly 14 includes all of the preceding components. It should be understood that the detection assembly 14 could also include different types of detectors to detect different gases or airborne materials, such as in a commercial setting where other gases or hazardous materials might be present. For example, in the automotive repair industry, it is common to spray paint vehicles or treat them with chemicals in a garage, which could release gases and airborne materials that could result in asphyxiation. Therefore, the detection assembly 14 could include a variety of detectors. In addition, the detection assembly 14 also includes an audible alarm 44 as is common for smoke detectors.

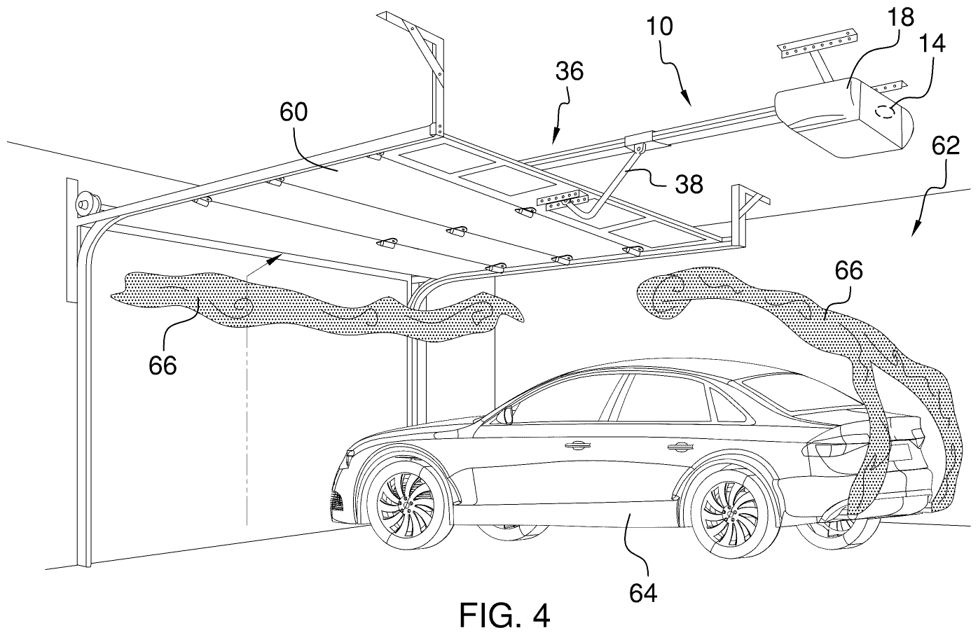

The automatic garage door safety system 10 is used to protect humans and animals from asphyxiation in a closed or poorly ventilated environment, specifically a room 62, such as a garage, that is openable and closable with the garage door 60. In use, the detection assembly 14 detects an atmospheric condition in the room 62. A shown in FIG. 3, for example, the detection assembly 14, depending on the design, could detect the presence of carbon monoxide 66 being exhausted from an automobile 64. The detection assembly 14 sends information regarding the atmospheric condition to the control unit 16. The control unit 16 then analyzes the information and, upon detecting that the atmospheric condition is hazardous to humans, activates the motor 20 and opens the garage door 60. The opening of the garage door 60 thereby allows the room 62 to ventilate by allowing the smoke, carbon monoxide, or other harmful gas or airborne material, to escape the room 62 via the large opening created by the garage door 60, as shown in FIG. 4, for example.

In one possible embodiment, the microprocessor would be programmed to only activate the motor 20 when the levels or amounts of gases or airborne materials are actually hazardous to avoid unintentional opening when detecting small or trace amounts of such gases or airborne materials. For example, the motor 20 is only activated when smoke or carbon monoxide at or above a predefined level is detected.

In another possible embodiment, the detection assembly 14 could alternatively or additionally include the oxygen sensor, which would be used to detect oxygen levels in the room 62 as opposed to detecting the presence of other gases or airborne materials. The microprocessor would be programmed to only activate the motor 20 when the level or amount of oxygen is at or below a predefined level. In this embodiment, regardless of the gases or airborne materials that are lowering the level of oxygen in the garage, the garage door 60 will be opened when the oxygen level is at or below a predefined level considered to be necessary to sustain humans.

In embodiments that include the audible alarm, a loud alarm sound will be emitted in addition to the garage door 60 being opened. The audible alarm will alert other persons to provide aid and would alert any persons in the room 62 to exit the room 62, especially in situations where a lack of oxygen may have rendered a person in the room 62 disoriented or unconscious.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automatic garage door safety system comprising:
a drive assembly comprising a motor and a mechanical arm assembly configured to operatively connect said motor to a garage door;
a detection assembly configured to detect an atmospheric condition in a room openable and closable by a garage door;
a control unit operatively connected to said motor and said detection assembly and configured to activate said motor to open a garage door upon receiving information from said detection assembly indicating an atmospheric condition hazardous to humans; and
a housing containing said motor, said detection assembly, and said control unit.

2. The automatic garage door safety system of claim 1, wherein said control unit is connected to each of said motor and said detection assembly by electric wires.

3. The automatic garage door safety system of claim 2, wherein said detection assembly comprises a smoke detector.

4. The automatic garage door safety system of claim 2, wherein said detection assembly comprises a carbon monoxide detector.

5. The automatic garage door safety system of claim 2, wherein said detection assembly comprises a smoke detector and a carbon monoxide detector.

6. The automatic garage door safety system of claim 2, wherein said detection assembly comprises an oxygen sensor.

7. The automatic garage door safety system of claim 2, wherein said detection assembly comprises a smoke detector, a carbon monoxide detector, and an oxygen sensor.

8. The automatic garage door safety system of claim 2, wherein said control unit comprises a microprocessor.

9. The automatic garage door safety system of claim 8, wherein said detection assembly comprises an audible alarm.

10. The automatic garage door safety system of claim 2, wherein said detection assembly comprises an audible alarm.

11. The automatic garage door safety system of claim 1, wherein said detection assembly comprises a smoke detector.

12. The automatic garage door safety system of claim 1, wherein said detection assembly comprises a carbon monoxide detector.

13. The automatic garage door safety system of claim 1, wherein said detection assembly comprises a smoke detector and a carbon monoxide detector.

14. The automatic garage door safety system of claim 1, wherein said detection assembly comprises an oxygen sensor.

15. The automatic garage door safety system of claim 1, wherein said detection assembly comprises a smoke detector, a carbon monoxide detector, and an oxygen sensor.

16. A method of using the automatic garage door safety system of claim 1, comprising the steps of:
detecting with said detection assembly an atmospheric condition in a room openable and closable by a garage door;
sending information regarding the atmospheric condition from said detection assembly to said control unit; and
analyzing the information and, upon detecting that the atmospheric condition is hazardous to humans, activating said motor opening the garage door.

17. The method of claim 16, wherein said detection assembly comprises a smoke detector, and said method further comprises detecting smoke at or above a predefined level and opening the garage door.

18. The method of claim 16, wherein said detection assembly comprises a carbon monoxide detector, and said method further comprises detecting carbon monoxide at or above a predefined level and opening the garage door.

19. The method of claim 16, wherein said detection assembly comprises an oxygen sensor, and said method further comprises detecting oxygen at or below a predefined level and opening the garage door.

20. The method of claim 16, wherein said detection assembly comprises an audible alarm, and said method further comprises activating said audible alarm upon detecting that the atmospheric condition is hazardous to humans.
